(19) United States
(12) Patent Application Publication
(10) Pub. No.: US 2026/0110815 A1
(43) Pub. Date: Apr. 23, 2026

(54) RECONSTRUCTING THREE-DIMENSIONAL SUBSURFACE IMAGE VOLUMES BASED ON TWO-DIMENSIONAL SEISMIC IMAGES

(71) Applicants: SCHLUMBERGER TECHNOLOGY CORPORATION, Sugar Land, TX (US); GEOQUEST SYSTEMS B.V., The Hague (NL)

(72) Inventors: Cen Li, Houston, TX (US); Haibin Di, Houston, TX (US); Wenyi Hu, Houston, TX (US); Zhun Li, Houston, TX (US); Aria Abubakar, Houston, TX (US)

(21) Appl. No.: 19/153,068

(22) PCT Filed: May 30, 2024
(86) PCT No.: PCT/US2024/031614

§ 371 Date: Aug. 1, 2025

Related U.S. Application Data
(60) Provisional application No. 63/469,697, filed on May 30, 2023.
(60) Provisional application No. 63/471,180, filed on Jun. 5, 2023.

(51) Int. Cl. G01V 1/34

(52) U.S. Cl. CPC G01V 1/345; G01V 2210/66

(57) ABSTRACT

A method of generating a three-dimensional (3D) seismic image volume includes receiving a plurality of two-dimensional (2D) seismic images. The method also includes generating a proxy volume representative of a three-dimensional volume that corresponds to the 3D seismic image volume based on the plurality of 2D seismic images, the proxy volume including multiple approximated 2D seismic images. The method also includes generating an approximate image volume including a first plurality of seismic images along a first trajectory based on updating the plurality of approximated 2D seismic images via a first machine learning algorithm. Further, the method includes generating the 3D seismic image volume including a second plurality of seismic images based on updating the first plurality of seismic images via a second machine learning algorithm in a second trajectory different from the first trajectory.

### CROSS-REFERENCE TO RELATED APPLICATIONS

This application claims priority to U.S. Provisional Application No. 63/469,697, filed May 30, 2023, titled “RECONSTRUCTING THREE-DIMENSIONAL SUBSURFACE IMAGE VOLUMES BASED ON TWO-DIMENSIONAL SEISMIC IMAGES,” and U.S. Provisional Application No. 63/471,180, filed on Jun. 5, 2023, titled “RECONSTRUCTING THREE-DIMENSIONAL SUBSURFACE IMAGE VOLUMES BASED ON TWO-DIMENSIONAL SEISMIC IMAGES,” the disclosures of which are incorporated by reference in their entirety for all purposes.

### INTRODUCTION

The present disclosure relates generally to performing seismic surveys. In particular, the present disclosure generally relates to performing seismic surveys in land and marine environments, including transition zones.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Three-dimensional seismic imaging is an effective tool for obtaining information about subsurface geological structures for the purpose of hydrocarbon exploration, reservoir production monitoring and planning, geologically sequestered CO2 plume body monitoring, and many other applications that assist in subsurface characterization processes.

In certain scenarios, after a baseline three-dimensional seismic dataset is acquired, additional seismic monitoring data acquisition surveys may be conducted to monitor the movement of the three-dimensional subsurface geological structures over time. However, acquiring the additional seismic monitoring data acquisition surveys may be a cost and time inefficient method for reconstructing the three-dimensional seismic images. Three-dimensional seismic imaging may generate large amounts of data that may be difficult to store, process, or interpret. Further, acquiring three-dimensional seismic imaging with adequate resolution for interpretation may be challenging at significant depths or in particularly complex geologic environments.

Given these shortcomings and other challenges associated with seismic imaging, an efficient and effective solution is needed. In particular, a solution that generates accurate seismic imaging more efficiently than three-dimensional seismic data acquisition may be desired.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, a method of generating a three-dimensional (3D) seismic image volume includes receiving a plurality of two-dimensional (2D) seismic images. The method also includes generating a proxy volume representative of a three-dimensional volume that corresponds to the 3D seismic image volume based on the plurality of 2D seismic images, the proxy volume including multiple approximated 2D seismic images. The method also includes generating an approximate image volume including a first plurality of seismic images along a first trajectory based on updating the plurality of approximated 2D seismic images via a first machine learning algorithm. Further, the method includes generating the 3D seismic image volume including a second plurality of seismic images based on updating the first plurality of seismic images via a second machine learning algorithm in a second trajectory different from the first trajectory.

In another embodiment, a computer program including computer-executable instructions that, when executed, cause at least one processor to perform operations including generating a first image of a three-dimensional (3D) approximate volume representative of subsurface region via a first machine learning model based on a 3D proxy volume representative of the subsurface region, updating the first image by providing, as input to the first machine learning model, one or more first residuals between the first image and one or more first corresponding two-dimensional (2D) seismic samples, and generating a second image of a 3D seismic volume representative of the subsurface region via a second machine learning model based on the updated first image, and updating the second image by providing, as input to the second machine learning model, one or more second residuals between the second image and one or more second corresponding two-dimensional (2D) seismic samples, wherein the updated second image corresponds to the 3D seismic volume.

In yet another embodiment, a system includes a memory storing instructions and a processor that executes the instructions to cause the processor to receive a plurality of two-dimensional (2D) seismic images, generate a proxy volume representative of a three-dimensional volume that corresponds to the 3D seismic image volume based on the plurality of 2D seismic images, wherein the proxy volume comprises a plurality of approximated 2D seismic images, generate an approximate image volume comprising a first plurality of crossline seismic images along a first trajectory based on updating the plurality of inline approximated 2D seismic images via a machine learning algorithm, and generate a 3D seismic image volume comprising a second plurality of seismic images based on updating the first plurality of crossline seismic images via the machine learning algorithm in a second trajectory different from the first trajectory.

### BRIEF DESCRIPTION OF THE DRAWING

These and other features, aspects, and advantages of the present disclosure will become better understood when the following detailed description is read with reference to the accompanying drawings in which like characters represent like parts throughout the drawings, wherein:

FIG. 1 is a schematic diagram of a water seismic survey and a land seismic survey using multiple seismic measurements, according to an embodiment of the present disclosure;

FIG. 2 is an illustration of an example of ocean bottom node (OBN) measurement employed in the water seismic survey, according to an embodiment of the present disclosure;

FIG. 3 is a flowchart of a method for generating a three-dimensional (3D) proxy volume for a seismic survey, according to an embodiment of the present disclosure;

FIG. 4 is an illustration of seismic images and volumes corresponding to the method of FIG. 3, according to an embodiment of the present disclosure;

FIG. 5 is a data flow chart of a process to generate a 3D seismic volume based on a proxy volume by generating an approximate volume, according to an embodiment of the present disclosure;

FIG. 6 is a data flow chart of a process for inputting the proxy volume of into a first machine learning model to generate the approximate volume of FIG. 5, according to an embodiment of the present disclosure;

FIG. 7 is a data flow chart of a process for inputting the approximate volume of FIG. 5 into a second machine learning model to generate the 3D seismic volume of FIG. 5, according to an embodiment of the present disclosure; and

FIG. 8 is a flow chart of a method for generating proxy volume and generating a 3D seismic volume based on the proxy volume, according to an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiment of the present disclosure, the articles “a,” “an,” “the,” and “said” are intended to mean that there are one or more of these elements. The terms “comprising,” “including,” and “having” are intended to be inclusive and mean that there may be additional elements other than the listed elements.

As mentioned, three-dimensional (3D) seismic data acquisition may be an effective tool to obtain the information of subsurface geological structures for the purpose of hydrocarbon exploration, reservoir production monitoring and planning, geologically sequestered carbon dioxide plume body monitoring, and many other applications that involve subsurface characterization. Unfortunately, 3D seismic data acquisition and the subsequent data processing procedure can be expensive and time-consuming, thereby making this acquisition process economically impractical in many scenarios. 3D seismic data acquisition may generate large amounts of data, which may be computationally intensive to process and/or difficult to store. A cost-effective solution to this problem is to acquire multiple two-dimensional (2D) seismic lines (e.g., seismic images, seismic traces) with a certain line layout pattern. 2D seismic data acquisition may involve substantially fewer seismic lines, and thus fewer sensor arrays, seismic sources, personnel, and so on, than 3D seismic data acquisition. Further, 2D seismic datasets may be less computationally intensive to process and store than 3D seismic datasets. These 2D seismic datasets may be processed to generate 2D subsurface seismic images, which may then be used to reconstruct a 3D seismic image volume in accordance with the embodiments described below.

For instance, a set of 2D seismic lines acquired by seismic data sources may include seismic images that span in an inline direction and a crossline direction, such that a subset of the 2D seismic lines are substantially perpendicular to the remainder of the 2D seismic lines. As such, in some embodiments, a first subset of the 2D seismic lines may be substantially parallel to each other and a second subset of the 2D seismic lines may be substantially perpendicular to the first subset. Prior to forming a 3D seismic image volume, in some embodiments, a seismic computing system may generate a synthetic 3D volume or proxy volume (e.g., starting volume, less accurate volume), which may be used for constructing the 3D seismic image volume.

The seismic computing system may then first align the 2D seismic lines in a 3D space. This alignment of the 2D seismic images may be accomplished via one or more image processing techniques (e.g., feature matching, registration, denoising, spectral shaping, etc.). The aligned 2D seismic images may be used to generate a plurality of horizons via a machine learning technique or manual picking and interpretation procedure (e.g., segmentation, neural networks, etc.). A 2D relative geology time (RGT) model may also generated from the plurality of horizons via an additional machine learning technique (e.g., deep neural network, convolutional neural network, etc.), which may be interpolated to form a 3D geology time volume. The seismic computing system may then convert the 3D geology time model to a 3D reflectivity model (e.g., reflection coefficient volume) by introducing a plurality of reflectors with randomly assigned reflection coefficients, such that each reflector is constructed based on the same geology time. The 3D reflectivity model may then be convolved with a predefined seismic source wavelet to generate the 3D seismic volume. The 3D seismic volume may be used as the proxy volume described herein.

Alternatively, after the 2D RGT model is generated, 2D artificial reflectors may be introduced with randomly assigned reflection coefficients, such that each 2D reflector is constructed based on the same geology time. A 3D reflectivity model may be obtained by interpolating/extrapolating the 2D reflectors to the 3D volume. The 3D reflectivity model may then be convolved with a predefined seismic source wavelet to generate the 3D seismic volume to be used as the proxy volume.

It should be noted that the proxy volume is an imprecise baseline of the 3D seismic volume. Although the proxy volume may resemble patterns found in the 3D seismic volume, the proxy volume may not resemble the overall appearance of seismic data. In certain embodiments, a plurality of proxy volumes may be input to an image reconstruction process to generate seismic images.

With the foregoing in mind, the seismic computing system may use the proxy volume to reconstruct a three-dimensional seismic image volume using updated 2D seismic images acquired via 2D seismic surveys. In some embodiments, the seismic computing system may input the proxy volume into a first machine learning algorithm (e.g., deep learning algorithm, neural network, convolutional neural network, etc.), which may evaluate images from the proxy volume along the inline direction. The first machine learning algorithm may compute residuals using the 2D seismic lines (e.g., labeled data, 2D traces) and the corresponding (e.g., coinciding) location on each inline image selected from the proxy volume. That is, the location where the 2D seismic lines coincide with the inline image. The seismic computing system may use residuals to update parameters (e.g., coefficients, offsets, etc.) of the first machine learning algorithm. Based on updating the parameters via the residuals, the first machine learning algorithm causes each inline image of the proxy volume to converge to the 2D seismic lines, thereby producing an image that more closely resembles seismic data. The transformed inline images taken together form an approximate volume, which is generated by the first machine learning algorithm.

In some embodiments, the approximate volume may then be input into a second machine learning algorithm (e.g., deep learning algorithm, neural network, convolutional neural network, etc.), which takes images from the approximate volume along the crossline direction, which is perpendicular to the inline direction. The second machine learning algorithm computes residuals using the 2D seismic lines (e.g., labeled data, 2D traces) and the corresponding (e.g., coinciding) location on each crossline image selected from the proxy volume. The residuals may then be used to update parameters (e.g., coefficients, offsets, etc.) of the second machine learning algorithm. Based on the updating the parameters via the residuals, the second machine learning algorithm may cause each crossline image of the approximate volume to converge to the 2D seismic lines in the same direction, thereby producing an image that more closely resembles seismic data.

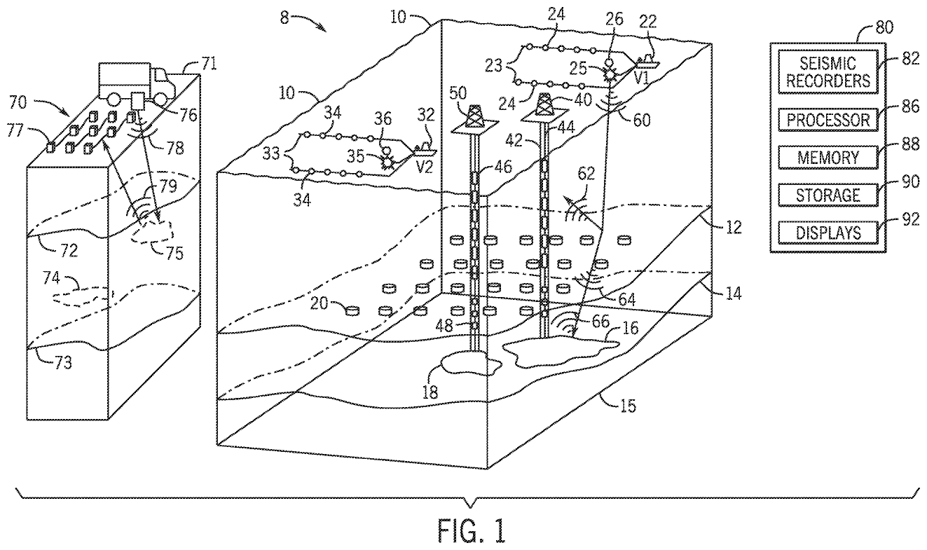

It should be noted that the second machine learning algorithm further improves the approximate volume due to using residuals along a different trajectory. Additional details regarding reconstructing 3D seismic image volumes based on 2D seismic images will be described below with reference to FIGS. 1-8. It should be noted that, while the inline and the crossline directions are described herein as being used for the network training and testing, residuals may be computed in any pattern, direction, or the like based on 2D seismic lines of various trajectories. Furthermore, this the techniques described herein may be repeated along multiple trajectories.

By way of introduction, FIG. 1 illustrates a schematic diagram of a water seismic survey and a land seismic survey using multiple seismic measurements. A water area 8 may include a surface 10 and a water bottom 12. Water depth in the shallow water area may vary from a few meters to 150 meters. Multiple subsurface layers (e.g., subsurface layers 14 and 15) may locate beneath the water bottom 12. Geological formations, such as subsurface formations 16 and 18 embedded in the subsurface layers, may contain hydrocarbon deposits. Seismic data acquired in the water seismic survey may be used to image the water bottom 12, the subsurface layers 14 and 15, and the subsurface formations 16 and 18. Images of subterranean geologic structures may provide indications of the hydrocarbon deposits.

The water seismic survey may include ocean bottom node (OBN) measurement by employing multiple OBNs 20 on the water bottom 12. The OBNs 20 may be deployed (e.g., using remotely operated vehicles (ROVs)) to selected locations and form a certain geometry (e.g., an OBN patch with 200 meters by 200 meters grid size). Each of the OBNs 20 may include one or more OBN sensors. The OBN sensors may include one or more geophones (e.g., single-component, two-component, three-component geophones). In some embodiments, the OBN sensors may also include hydrophones.

One or more seismic source vessels may be used in the shallow water seismic survey. For example, a source vessel 22 towing a seismic source 25 and another source vessel 32 towing another seismic source 35 may be used to create seismic waves propagating downward into the subterranean geologic structures. Each of the seismic sources 25 and 35 may include one or more source arrays and each source array may include a certain number of air guns.

The water seismic survey may also include streamer measurement by employing multiple streamers traversing the water. For example, the source vessel 22 may tow multiple (e.g., two, four, six, eight, or ten) streamers 23 along one sail line, and the source vessel 32 may tow multiple streamers 33 along another sail line. The streamer measurement may be acquired simultaneously with the OBN measurement using shots fired by the seismic sources 25 and 35. Each streamer may include multiple streamer sensors. For example, each of the streamers 23 may include streamer sensors 24 and each of the streamers 33 may include streamer sensors 34. The streamer sensors 24 and 34 may include hydrophones that create electrical signals in response to water pressure changes caused by reflected seismic waves that arrive at the hydrophones.

The water seismic survey may also include near field hydrophone (NFH) measurement by employing multiple NFHs close to the seismic sources. For example, an NFH 26 may be deployed in close proximity to the seismic source 25 and another NFH 36 may be deployed in close proximity to the seismic source 35. In a water environment, the NFH measurement may be used to improve estimates of near surface conditions and to create more accurate shallow velocity models. Moreover, the NFH measurement may provide small-offset data missing from streamer measurement that may be useful for multiple attenuation. Offset may be referred to as a distance between a seismic source and a seismic receiver or sensor. The NFH measurement may be combined with streamer measurement to improve seismic data processing such as multiple attenuation, wavelet estimation, and de-bubble.

The water seismic survey may further include vertical seismic profile (VSP) measurement by employing seismic sensors (e.g., fiber-optic sensors, geophones, or hybrid sensors) in one or more wells. For example, a hybrid sensor array including fiber-optic sensors 46 and geophones 48 may be disposed along a wireline cable 44 deployed in a borehole 42 of a well 40, which may be drilled into the subsurface formation 16. Similar seismic sensors may be deployed in another well 50, which may be drilled into the formation 18. The fiber-optic sensors 46 may measure strains caused by reflected or refracted seismic waves traveling along the hybrid sensor array. The geophone 48 may measure ground motions (e.g., particle movements such as velocity and acceleration) caused by seismic waves traveling along the hybrid sensor array.

During the water seismic survey, the seismic source 25 may be activated to generate seismic waves 60 traveling downward into the subterranean geologic structures. When the seismic waves 60 arrives at the water bottom 12, a portion of seismic energy contained in the seismic waves 60 is reflected by the water bottom 12. Reflected waves 62 travel upward and arrive at different sensors, such as the streamer sensors 24 and 34, the near field hydrophones 26 and 36, and the fiber-optic sensors 46, where they are measured by corresponding sensors. Another portion of the seismic energy contained in transmitted seismic waves 64 propagated through the water bottom 12 into the subsurface layer 14. A portion of seismic energy contained in the transmitted waves 64 is reflected by the subsurface formation 16. Reflected waves 66 travel upward and arrive at the different sensors, where they are measured by the corresponding sensors.

A land area may include a land surface 71, subsurface layers 72 and 72, and subsurface formations 74 and 75 embedded in the subsurface layers 72 and 73 that may contain hydrocarbon deposits. Seismic data acquired in the land seismic survey may be used to image the subsurface layers 72 and 72, and subsurface formations 74 and 75. Images of subterranean geologic structures may provide indications of the hydrocarbon deposits.

The land seismic survey may include a seismic vibrator 76 in direct contact with the land surface 71 (e.g., hydraulically driven vibrating plate) that vibrates to generates seismic waves 78 at certain frequencies, durations, and intensities. The seismic vibrator 76 may be attached to a vehicle that moves along paths on the land surface 71, allowing the seismic vibrator 76 to direct the seismic waves 78 at different directions within a volume of the land seismic survey. The seismic waves 78 generated by the seismic vibrator 76 may propagate downward into the subterranean geologic structures, and a portion of the seismic waves 78 may reflect off of the subterranean geologic structures as reflected waves 79. The reflected waves 79 may travel upwards and arrive at an array or one or more land-based sensors (e.g., land-based hydrophones) 77, where they are measured by the one or more land-based sensors 77.

It should be noted that the elements described above with regard to the shallow water seismic survey and land seismic survey are exemplary elements. For instance, some embodiments of the shallow water seismic survey and/or the land seismic survey may include additional or fewer elements than those shown. In some embodiments, the shallow water seismic survey may include different number of source vessels. In some embodiments, separated receiver vessels may be used to tow the streamers. In some embodiments, the streamer measurement may be acquired independently from the OBN measurement for operational or logistical reasons.

Seismic data acquired from different sensors may be collected and processed by a processing system 80. The processing system 80 may include one or more seismic recorders 82, a processor 86, a memory 88, a storage 90, and one or more displays 92. The one or more seismic recorders 82 may receive ocean bottom node (OBN) data from OBNs 20, streamer data from streamer sensors 24 and 34, near field hydrophone (NFH) data from the NFHs 26 and 36, a portion of vertical seismic profile (VSP) data from geophones 48, and seismic data from the one or more land-based sensors 77. Collected data may be processed by the processor 86 using processor-executable code stored in the memory 88 and the storage 90. The processed data may be stored in the storage 90 for later usage. Processing results may be displayed via the one or more displays 92.

The processor 86 may be any type of computer processor or microprocessor capable of executing computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, interrogator 84, memory 88, storage 90, and one or more displays 92).

The memory 88 and the storage 90 may be any suitable articles of manufacture that can serve as media to store processor-executable code, data, or the like. These articles of manufacture may represent computer-readable media (e.g., any suitable form of memory or storage) that may store the processor-executable code used by the processor 86 to perform the presently disclosed techniques. The memory 88 and the storage 90 may also be used to store data described (e.g., fiber sensor data, geophone data), various other software applications for seismic data analysis and data processing. The memory 88 and the storage 90 may represent non-transitory computer-readable media (e.g., any suitable form of memory or storage) that may store the processor-executable code used by the processor 86 to perform various techniques described herein. It should be noted that non-transitory merely indicates that the media is tangible and not a signal.

The one or more displays 92 may operate to depict visualizations associated with software or executable code being processed by the processor 86. The display 92 may be any suitable type of display, such as a liquid crystal display (LCD), plasma display, or an organic light emitting diode (OLED) display.

It should be noted that the components described above with regard to the processing system 80 are exemplary components and the processing system 80 may include additional or fewer components as shown. For example, the processing system 80 may include one or more communication interfaces to send commands to different seismic acquisition systems and receive measurement from the different seismic acquisition systems.

As mentioned previously, ocean bottom acquisition systems including the ocean bottom node (OBN) or the ocean bottom cable (OBC) may be utilized to obtain more accurate seismic survey data in water complex geologic areas. For example, a seismic survey employing OBNs in shallow water having complex geologic structures may involve deploying an OBN patch (e.g., a 2D OBN array) and a dense grid of sources to effectively image the subsurface from the water bottom to a certain depth. The dense grid of sources may be produced by multiple seismic vessels sailing along one or more sides of the OBN patch.

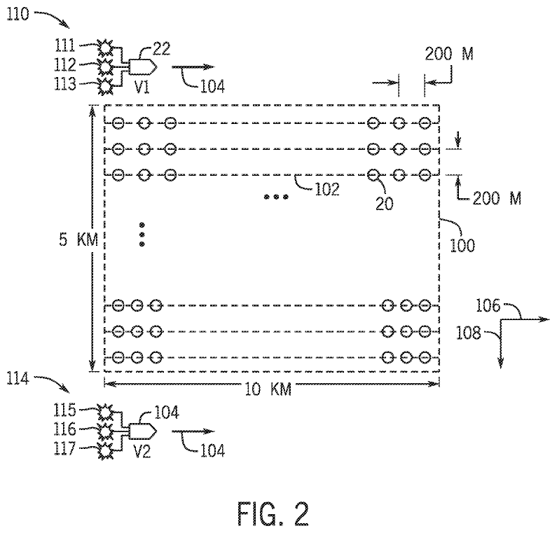

With this in mind, FIG. 2 illustrates an example of ocean bottom node (OBN) measurement employed in the water seismic survey. An OBN patch 100 may be deployed on the water bottom 12. The OBN patch 100 may include multiple (e.g., 25) receiver lines 102 each having a length of 10 kilometers. A distance between two adjacent receiver lines 102 is approximately 200 meters (e.g., 190-210 meters), thereby the OBN patch 100 including 25 receiver lines 102 may have a width of approximately 5 kilometers (e.g., 3-6 km). Two source vessels 22 and 32 may be used to produce source signals (e.g., seismic waves via air guns). The reflected or refracted seismic waves (e.g., reflected waves 66) may be detected by the OBNs 20 disposed along the receiver lines 102. The OBNs 20 may have a 200 meters×200 meters receiver (node) spacing. The source vessels 22 and 32 may move along a sail line direction 104 that is parallel to the receiver lines 102. The sail line direction 104 may be referred to as an inline direction 106. A direction perpendicular to the sail line direction 104 may be referred to as a crossline direction 108.

In some embodiments, each source vessel may be equipped with a triple source array. For example, a source array 110 towed by the source vessel 22 may include sources 111, 112, and 113 and another triple source array 114 towed by the source vessel 32 may include sources 115, 116, and 117. A distance between two adjacent sources (e.g., between sources 111 and 112 or sources 112 and 113) may be approximately 50 meters (e.g., 47.5-52.5 meters). An OBN source grid with a dense source sampling spacing may be used for the shallow water seismic survey. For example, a 37.5 meters×50 meters shot spacing may be used during the shallow water seismic survey if each source fires with a shot interval approximately 12.5 m (e.g., 12-13 meters) along the inline direction 106 in a flip-flop-flap mode (e.g., each of the sources 111, 112, and 113 firing alternatively).

While the OBN patch 100 is described as part of a water seismic survey, a similar arrangement of sensors, such as the one or more land-based sensors 77 of FIG. 1., may be used for a land seismic survey. For example, the one or more land-based sensors 77 may be positioned on the land surface 71 in an arrangement similar to the OBN patch 100, and may measure reflected waves in an inline direction and a crossline direction perpendicular to the inline direction. Inline measurements from a subset of the one or more land-based sensors 77 spanning the inline direction in parallel may be used to generate seismic inline 2-dimensional images of a subterranean volume (e.g., land-based subterranean volume). Likewise, crossline measurements from a portion of the one or more land-based sensors 77 spanning the crossline direction in parallel may be used to generate crossline seismic 2-dimensional images of the subterranean volume. Further, multiple seismic inline 2D images and multiple seismic crossline 2D images may be generated and used together to analyze a subterranean volume, which may include, for example, the subsurface layers 72 and 72 and the subsurface formations 74 and 75. As described herein, inline 2D images and crossline 2D images may be used to generate a 3-dimensional proxy volume. Further, a proxy volume may be processed based on 2D seismic lines to generate or update a more accurate 3D seismic volume.

It should be noted that a land seismic survey or a water seismic survey may have an arrangement of sensors different than the OBN patch 100 shown in FIG. 2. Seismic sensors such as the OBNs 20 may be arranged differently according to, for example, characteristics of a volume being surveyed. Further, while subsets of 2D seismic images may be described herein as “inline images” and “crossline images” for ease of description, 2D images may be acquired at various angles with respect to inline 2D images, and should not be limited to being perpendicular with each other.

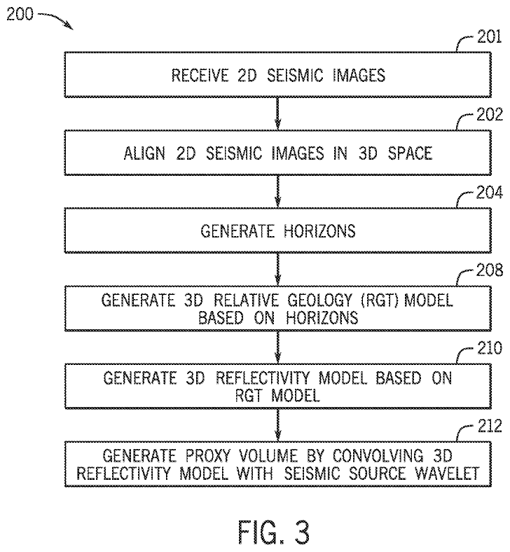

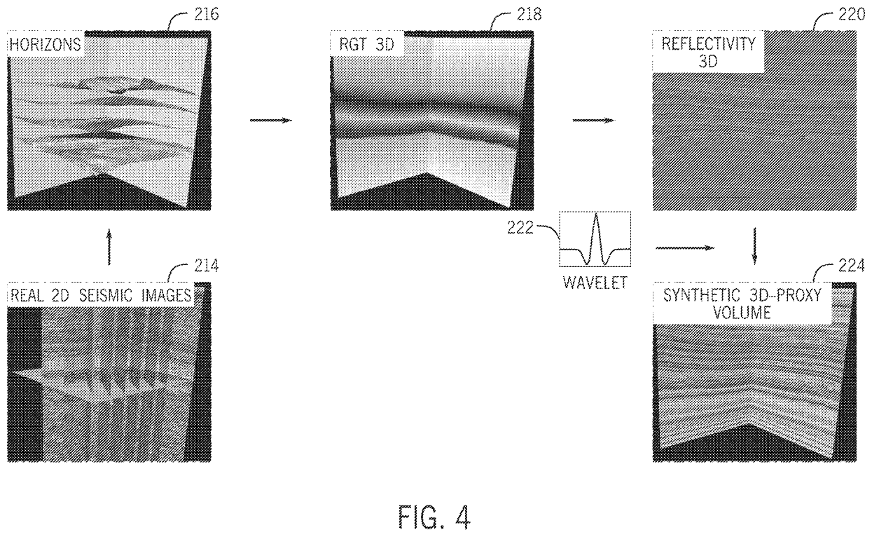

FIG. 3 is a flowchart of a method 200 for generating a 3D proxy volume for a seismic survey that may be performed by, for example, the processing system 80 of FIG. 1. The method 200 may be discussed with reference to FIG. 4, which illustrates seismic images and volumes corresponding to the method 200. The method 200 may begin, in block 201, with the processing system 80 receiving 2D seismic images 214, which may have been acquired in the marine survey or the land survey, as described above. In some embodiments, the 2D seismic images 214 may be stored in a database or other suitable storage component that includes 2D seismic images 214 for various types of subterranean regions.

In some embodiments, the 2D seismic images may be generated by the processing system 80 based on seismic measurements received from, for example, the OBNs 20, the streamer sensors 24 and 34, the NFHs 26 and 36, the geophones 48, and/or the land-based sensors 77. That is, the 2D seismic images may represent observed (e.g., actual) measurements of a surveyed volume. The 2D seismic images may include images of different trajectories, such as inline images and crossline images, and the images may be aligned at an angle (e.g., orthogonally) such that features of the surveyed volume (e.g., geologic formations) are aligned vertically at intersections of the images. Further, the 2D seismic images may be aligned along various trajectories (e.g., may not be limited to inline and crossline directions).

At block 202, the processing system 80 may align the 2D seismic images 214 in a 3D space. The processing system 80 may align the images of different trajectories (e.g., inline images and crossline images) in the 3D space via one or more image processing techniques to resolve inconsistencies between the images at the intersections, such as feature matching, registration, denoising, and/or spectral shaping.

In block 204, the processing system 80 may generate one or more horizons 216 based on the aligned 2D seismic images 214. Horizons 216 may include a 3D representation of aspects of a surveyed volume, such as subsurface layers, geologic formations, or other portions of a surveyed volume detectable by seismic survey. Horizons 216 generated by the processing system 80 may correspond to structures within a surveyed volume having particularly strong seismic signatures. To generate the horizons 216, the processing system 80 may identify contours within each of the aligned 2D images that correspond to features of a surveyed volume represented by the aligned 2D images. Because the features of the surveyed volume may not span the extents of a surveyed volume, each of the aligned 2D images may have varying numbers and locations of identified contours that correspond to different aspects of the surveyed volume. The processing system 80 may generate the horizons 216 by interpolating the identified contours of the aligned 2D seismic images 214 using a suitable machine learning technique, such as segmentation and/or one or more neural networks. The processing system 80 may, for example, use an optical flow machine learning technique to track the identified contours (e.g., 2D horizons) and may use additional interpolation and/or extrapolation techniques to generate the horizons 216. As illustrated in FIG. 4, the horizons 216 may include four vertically spaced three-dimensional structures, as an example. As may be appreciated, in other examples, fewer than four or more than four horizons of various shapes and sizes may be generated based on various aligned 2D images.

In block 208, the processing system 80 may generate a 3D relative geology time (RGT) volume 218 based on the horizons 216. The 3D RGT volume 218 may include relative geologic time values assigned throughout a surveyed volume (here illustrated as gray scale gradients), and the relative geologic time values may correspond to an order by which each portion of the surveyed volume was formed, deposited, or the like. The horizons 216 may provide insight into such an order by representing geologic boundaries between older and newer layers of sediment, horizontal depositions of sediment of the same age, and so on. The processing system 80 may thus generate the 3D RGT volume 218 based on the horizons 216 using additional machine learning techniques, such as deep neural networks, convolutional neural networks, and the like. In an embodiment, the processing system may first generate one or more 2D RGT images based on the horizons and the aforementioned machine learning techniques, and may then interpolate or extrapolate the 2D RGT images to form the 3D RGT volume 218. In another embodiment, the one or more 2D RGT images used to form the 3D RGT volume 218 may be generated based on one or more selected 2D horizons (e.g., contours) of the aligned 2D seismic images 214.

In block 210, the processing system 80 may generate a 3D reflectivity volume 220 based on the 3D RGT volume 218. The 3D reflectivity volume 220 may include multiple (e.g., 100 or more) contours (e.g., reflectors), each contour having a randomly assigned reflection coefficient. Further, each contour may have the same RGT value in the 3D RGT volume 218, and may thus characterize a portion of a surveyed volume with the same geologic age. For example, a contour in the 3D reflectivity volume 220 may have a common RGT value (e.g., illustrated as deep blue) along the span of the contour. That is, a contour may not have a first RGT value (e.g., illustrated as deep blue) and a second RGT value (e.g., illustrated as orange) at different points along the contour.

In block 212, the processing system 80 may generate a proxy volume 224 by convolving the 3D reflectivity volume 220 with a predefined seismic wavelet 222. The processing system 80 may use the proxy volume 224 to generate a 3D seismic volume according to the techniques described herein. It should be noted that the proxy volume 224 may be an imprecise baseline of the 3D seismic volume. Although the proxy volume 224 may resemble patterns found in the 3D seismic volume, the proxy volume may not closely resemble the overall appearance of seismic data. As such, the processing system may employ additional processing to convert the proxy volume 224 into a more accurate 3D seismic volume. However, in some embodiments, the proxy volume 224 may be used without additional processing.

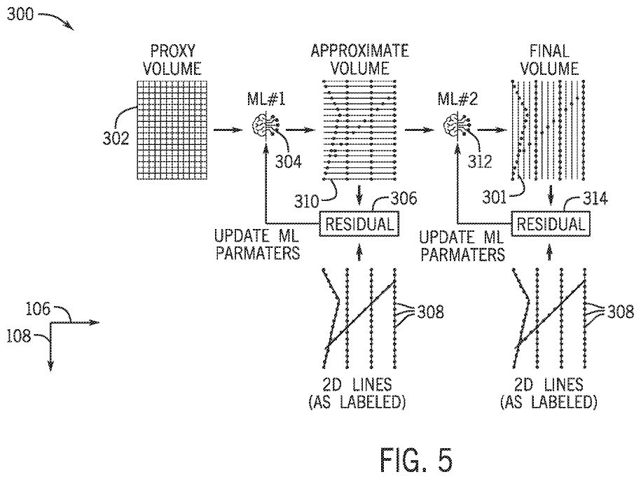

Keeping this in mind, FIG. 5 is a diagram of a process 300 that may be performed by the processing system 80 to generate a 3D seismic volume 301 based on a proxy volume 302. It should be noted that, while the proxy volume 224 generated based on the method 200 is provided as an example of a proxy volume 302 used for the process 300, other proxy volumes generated based on other techniques may be used for the process 300. For example, a 3D seismic volume in a neighboring area sharing similar geological environments and/or similar geophysical attributes present in the 2D seismic lines 308 may be used as the proxy volume 302. In another example, the proxy volume 302 may include an initial and/or prior 3D seismic volume of an area, and the 2D seismic lines 308 may be measured at a later date to measure geological changes to the area. Further, in some cases, multiple proxy volumes (e.g., multiple proxy volumes generated by the method 200) may be merged (e.g., via averaging or deep learning methods) and used as the proxy volume 302. Additionally or alternatively, multiple proxy volumes may be input to the machine learning models described herein via multiple channels (e.g., input channels) of the machine learning models.

As illustrated, the processing system 80 may input a proxy volume 302 into a first machine learning model 304 (e.g., machine learning algorithm, deep learning algorithm, neural network, convolutional neural network, etc.), which may evaluate 2D images of the proxy volume 302 along a first trajectory (e.g., the inline direction 106). It should be noted that, while the first machine learning model 304 may be described herein as evaluating 2D images of the proxy volume 302 along the inline direction 106 for ease of discussion, the first machine learning model 304 may evaluate 2D images of the proxy volume 302 along multiple various trajectories, patterns, curvatures, and so on, as illustrated. It should also be noted that, with the inline direction 106 and the crossline direction 108 in mind, the proxy volume 302 is illustrated in FIG. 5 is depicted from a top-down view (e.g., as if being viewed downward into a surveyed volume). As shown, the first machine learning algorithm 304 may compute residuals 306 using 2D seismic lines 308. 2D seismic lines 308, also referred herein to as 2D traces, may include seismic measurements that extend downward into a surveyed volume. The 2D seismic lines 308 may, as illustrated, be acquired according to a grid pattern or other layout of a seismic survey. Importantly, these 2D seismic lines 308 may be less costly to measure than entire 2D images that span an extent of a surveyed volume. The processing system 80 may use the first machine learning model 304 to compute residuals 306 between the 2D seismic lines 308 and the corresponding (e.g., coinciding) location on each inline image selected from the proxy volume 302 (e.g., the location where the 2D seismic lines coincide with the inline image). The processing system 80 may use the residuals 306 to update parameters (e.g., coefficients, offsets, etc.) of the first machine learning algorithm 304. Based on updating the parameters via the residuals 306, the first machine learning algorithm 304 causes each inline image of the proxy volume 302 to converge to the 2D seismic lines 308, thereby producing images that more closely resembles measured seismic data. The processing system 80 may combine the transformed inline images generated by the first machine learning algorithm 304 to form an approximate volume 310.

The processing system 80 may then input the approximate volume 310 into a second machine learning model 312 that evaluates the approximate volume 310 along a second trajectory (e.g., the crossline direction 108), which is different than the first trajectory (e.g., the inline direction 106). It should be noted that, while the second machine learning model 312 may be described herein as evaluating 2D images of the approximate volume 210 along the crossline direction 108 for ease of discussion, the second machine learning model 312 may evaluate 2D images of the approximate volume 310 along various trajectories, curvatures, and so on, as illustrated. As shown, the second machine learning algorithm 312 computes residuals 314 using 2D seismic lines 308 and the corresponding location on each crossline image selected from the approximate volume 310. The residuals 314 may then be used to update parameters of the second machine learning algorithm 312. Based on the updating the parameters via the residuals 314, the second machine learning algorithm 312 causes each crossline image of the approximate volume 310 to converge to the 2D seismic lines 308 in the same direction, thereby producing an image that more closely resembles seismic data. It should be noted that, while the second machine learning model 312 may use similar techniques as those used by the first machine learning model 304, the second machine learning model 312 may improve the approximate volume 310 by considering residuals 314 in a trajectory different than (e.g., orthogonal to) the residuals 306. The processing system 80 may combine the transformed crossline images generated by the second machine learning algorithm 312 to form the 3D seismic volume 301.

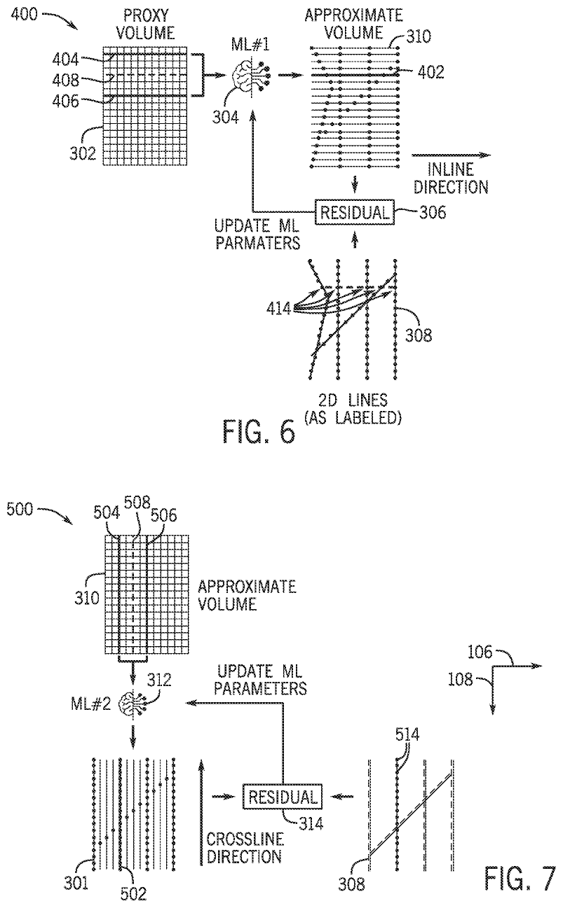

FIG. 6 is a data flow chart of a process 400 by which the processing system 80 may input the proxy volume 302 into the first machine learning model 304 to generate the approximate volume 310. The process 400 may be performed as part of, or in conjunction with, the process 300 of FIG. 5. The processing system 80 may generate the approximate volume 310 image-by-image based on images along a first trajectory (e.g., inline images) of the proxy volume 302. In the illustrated embodiment, the processing system 80 may compute an i^{th} inline image 402 of the approximate volume 310 by inputting an (i−y)^{th} inline image 404 and an (i+y)^{th} inline image 406 of the proxy volume 302 into the first machine learning model 304. The (i−y)^{th} inline image 404 and the (i+y)^{th} inline image 406 may be offset from an i^{th} image 408 of the proxy volume 302 by an offset y, which may be adjusted by the first machine learning model 304 or manually via the processing system 80 to adjust or improve the approximate volume 310. It should be noted that, while two inline images of the proxy volume 302 are used to compute the i^{th} inline image 402 in the illustrated embodiment, the processing system 80 may compute the i^{th} inline image 402 based on any number of inline images of the proxy volume 302 (e.g., 1, 2, 5, 10, or 100 inline images of the proxy volume). Further, as illustrated and discussed herein, the first trajectory along which the approximate volume 310 is generated may include various patterns, curvatures, and the like (e.g., may not be limited to inline image evaluation).

The processing system 80 may compare the ich inline image 402 at intersection points 414 with the 2D seismic lines 308 to compute the residuals 306. The intersection points 414 may include seismic lines that are present in both the i^{th} inline image 402 and the 2D seismic lines 308, as illustrated. The residuals 306 may be used to iteratively update the parameters of the first machine learning model 304 (e.g., via loss function minimization) until the i^{th} inline image 402 converges with the 2D seismic lines 308 at the intersection points 414.

As mentioned, the processing system 80 may generate the approximate volume 310 image-by-image. For example, after computing the i^{th} inline image 402, the processing system 80 may continue to generate additional inline images of the approximate volume 310 by inputting images of the proxy volume 302 offset by the y offset from the corresponding inline image of the proxy volume 302. The processing system 80 may compute additional inline images of the approximate volume 310 until, for example, residuals 306 are calculated and parameters of the first machine learning model 304 are updated for every inline image of the approximate volume 310 for which there are intersection points 414 with the 2D seismic lines 308. That is, the processing system 80 may incorporate the applicable 2D seismic lines 308 to improve the approximate volume 310.

FIG. 7 is a diagram of a process 500 by which the processing system 80 may input the approximate volume 310 into the second machine learning model 312 to generate the 3D seismic volume 301. As with the process 400 of FIG. 6, the process 500 may be performed as part of, or in conjunction with, the process 300 of FIG. 5. Further, similarly to the process 400 of FIG. 6, the processing system 80 may generate the 3D seismic volume 301 image-by-image. In the illustrated embodiment, the processing system 80 may compute a j^{th} crossline image 502 of the 3D seismic volume 301 by inputting an (j−x)^{th} crossline image 504 and an (j+x)^{th} crossline image 506 of the approximate volume 310 into the second machine learning model 312. The (j−x)^{th} crossline image 504 and the (j+x)^{th} crossline image 506 may be offset from an j^{th} image 508 of the approximate volume 310 by an offset x, which may be adjusted by the second machine learning model 312 or manually via the processing system 80 to improve the 3D seismic volume 301. It should be noted that, while two crossline images of the approximate volume 310 are used to compute the j^{th} crossline image 502 in the illustrated embodiment, the processing system 80 may compute the j^{th} crossline image 502 based on any number of crossline images of the approximate volume 310 (e.g., 1, 2, 5, 10, or 100 crossline images of the approximate volume 310). Further, as illustrated and discussed herein, the second trajectory along which the 3D seismic volume 301 is generated may include various patterns, curvatures, and the like (e.g., may not be limited to crossline image evaluation).

The processing system 80 may compare the j^{th} crossline image 502 at intersection points 514 with the 2D seismic lines 308 to compute the residuals 306. The intersection points 514 may include seismic lines that are present in both the j^{th} crossline image 502 and the 2D seismic lines 308, as illustrated. The residuals 314 may be used to iteratively update the parameters of the second machine learning model 312 until the j^{th} crossline image 502 converges with the 2D seismic lines 308 at the intersection points 514.

After computing the j^{th} crossline image 502, the processing system 80 may continue to generate additional crossline images of the approximate volume 310 by inputting crossline images of the approximate volume 310 offset by the x offset from the corresponding crossline image of the approximate volume 310. The processing system 80 may compute additional crossline images of the approximate volume 310 until, for example, residuals 314 are calculated and parameters of the second machine learning model 312 are updated for every crossline image of the 3D seismic volume 301 for which there are intersection points 514 with the 2D seismic lines 308. That is, the processing system 80 may incorporate all applicable 2D seismic lines 308 to improve the 3D seismic volume 301.

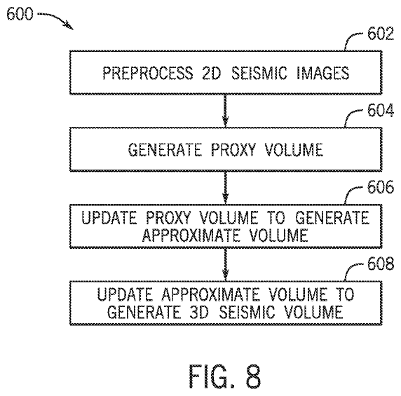

FIG. 8 is a flow chart of a method 600 for generating a 3D seismic volume. The method 600 may include portions of, for example, the methods 200 and/or 400 and/or the processes 300 and/or 500, and may be performed as part of the seismic surveys of FIG. 1. Accordingly, the method 600 may be described with reference to the preceding figures. In block 602, the processing system 80 may preprocess 2D seismic images 214 generated based on seismic measurements received from one or more sensors of a seismic survey. Preprocessing the 2D seismic images may include, for example, aligning the 2D seismic images 214 in a 3D space. The 2D seismic images may be generated by the processing system 80 based on seismic measurements received from, for example, the OBNs 20, the streamer sensors 24 and 34, the NFHs 26 and 36, the geophones 48, and/or the land-based sensors 77. That is, the 2D seismic images may represent observed measurements of a surveyed volume. The 2D seismic images may include inline images and crossline images, and the inline and crossline images may be aligned at an angle such that portions of the surveyed volume are aligned vertically at intersections of the inline images and the crossline images. The processing system 80 may align the inline images and crossline images in the 3D space via one or more image processing techniques, such as feature matching, registration, denoising, and/or spectral shaping.

In block 604, the processing system 80 may generate a proxy volume 302 based on the aligned 2D seismic images. This may include, for example, generating one or horizons 216 based on the aligned 2D seismic images 214. As discussed, herein, to generate the horizons 216, the processing system 80 may identify contours within each of the aligned 2D images that correspond to aspects of a surveyed volume represented by the aligned 2D images. The processing system 80 may generate the horizons 216 by interpolating the identified contours of the aligned 2D seismic images 214 using a suitable machine learning technique, such as segmentation and/or one or more neural networks, and/or using other suitable methods, such as manual picking methods. Block 604 may also include the processing system 80 generating a 3D RGT volume 218 based on the horizons 216. The 3D RGT volume 218 may include relative geologic time values assigned throughout a surveyed volume and the relative geologic time values may correspond to an order by which each portion of the surveyed volume was formed, deposited, or the like. Additionally, block 604 may include the processing system 80 generating a 3D reflectivity volume 220 based on the 3D RGT volume 218. The 3D reflectivity volume 220 may include multiple contours, each contour having a randomly assigned reflection coefficient. Further, each contour may have the same RGT value in the 3D RGT volume 218, and may thus characterize a portion of a surveyed volume with the same geologic age. The processing system 80 may then generate the proxy volume 224 by convolving the 3D reflectivity volume 220 with a predefined seismic wavelet 222.

In block 606, the processing system 80 may update the proxy volume 302 to generate the approximate volume 310. This may include, for example, inputting inline images of the proxy volume 302 into a machine learning model, and the machine learning model may be updated based on residuals between a computed inline image and measured seismic lines that intersect the computed inline image. Additionally or alternatively, block 606 may include inputting crossline images of the proxy volume 302 into the machine learning model, and the machine learning model may be updated based on residuals between a computed crossline image and measured seismic lines that intersect the computed crossline image. The machine learning model may iteratively update the approximate volume until the measured seismic lines intersect the computed crossline images or computed inline images.

In block 608, the processing system 80 may update the approximate volume 310 to generate the 3D seismic volume 301. As mentioned, the techniques described herein generate the 3D seismic volume 301 by updating the approximate volume 310 based on measured 2D seismic lines. Further, the 2D seismic lines may be less costly and more efficient to acquire than 3D seismic data, as described herein. As such, the 3D seismic volume 301 may accurately characterize a surveyed volume while being less resource-intensive to generate than 3D seismic data acquisition. Block 608 may include, for example, inputting crossline images of the approximate volume 310 into an additional machine learning model, and the additional machine learning model may be updated based on residuals between a computed crossline image and measured seismic lines that intersect the computed crossline image. Additionally or alternatively, block 608 may include inputting inline images of the approximate volume 310 into the additional machine learning model, and the additional machine learning model may be updated based on residuals between a computed inline image and measured seismic lines that intersect the computed inline image. The additional machine learning model may iteratively update the 3D seismic volume 301 until the measured seismic lines intersect the computed inline images or computed crossline images.

In some embodiments, block 602 and/or block 604 may be omitted. In a “time-lapse” example, the method 600 may be performed such that the proxy volume includes an initial measured 3D seismic volume generated based on seismic data measured at an initial time (e.g., t=0 years). Updated 3D seismic volumes may be generated periodically (e.g., at t=5 years, t=10 years, and so on) based on updated 2D seismic samples according to the techniques described herein. That is, a surveyed volume may be accurately characterized by the initial 3D seismic volume as the proxy volume, and blocks 606 and 608 may be performed based on the 2D seismic samples, which may reflect geologic changes over time. As such, the accuracy of an initial measured 3D seismic volume may be preserved, and geologic changes may be reflected in updated 3D seismic volumes based on less costly 2D seismic samples.

Additionally, multiple instances of blocks 602, 604, 606, and/or 608 may be performed in parallel. In one example, two instances of blocks 602, 604, and 606 may be performed to generate a first approximate volume based on inline images and a second approximate volume based on crossline images. The processing system 80 may then merge the first approximate volume and the second approximate volume using, for example, averaging or deep learning methods. In another example, blocks 602, 604, 606, and 608 may be performed in parallel to generate a first 3D seismic volume based on inline images and a second 3D seismic volume based on crossline images, and the processing system 80 may then merge the first approximate volume and the second approximate volume using suitable methods. Further, in some embodiments, the same machine learning model may be used for block 606 and 608, such that the same machine learning model generates the approximate volume and 3D seismic volume.

While only certain features of the invention have been illustrated and described herein, many modifications and changes will occur to those skilled in the art. It is, therefore, to be understood that the appended claims are intended to cover all such modifications and changes as fall within the true spirit of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function].” or “step for [perform]ing [a function] . . . ,” it is intended that such elements are to be interpreted under 35 U.S.C. § 112(f). However, for any claims containing elements designated in any other manner, it is intended that such elements are not to be interpreted under 35 U.S.C. § 112(f).

1-10. (canceled)

11. A computer program comprising computer-executable instructions that, when executed, are configured to cause at least one processor to perform operations comprising:
generating a first image of a three-dimensional (3D) approximate volume representative of subsurface region via a first machine learning model based on a 3D proxy volume representative of the subsurface region;
updating the first image by providing, as input to the first machine learning model, one or more first residuals between the first image and one or more first corresponding two-dimensional (2D) seismic samples;
generating a second image of a 3D seismic volume representative of the subsurface region via a second machine learning model based on the updated first image; and
updating the second image by providing, as input to the second machine learning model, one or more second residuals between the second image and one or more second corresponding two-dimensional (2D) seismic samples, wherein the updated second image corresponds to the 3D seismic volume.

12. The computer program of claim 11, wherein the first image is oriented in a crossline direction and the second image is oriented in an inline direction.

13. The computer program of claim 11, wherein the computer-executable instructions are configured to cause the at least one processor to perform operations comprising:
receiving a plurality of two-dimensional (2D) seismic images comprising a first set of images oriented along a first trajectory and a second set of images oriented along a second trajectory;
aligning the first set of images with the second set of images in a grid pattern to generate an aligned set of images based on a set of features in the first set of images with a corresponding set of features in the second set of images; and
generating the 3D proxy volume based on the aligned set of images.

14. The computer program of claim 11, wherein the one or more first corresponding 2D seismic samples and the one or more second corresponding 2D seismic samples are generated based on 2D seismic samples acquired at a time after the 3D seismic data is acquired.

15. The computer program of claim 11, wherein generating the first image of the 3D approximate volume via the first machine learning model based on the 3D proxy volume comprises:
providing, as input to the first machine learning model, one or more offset images of the 3D proxy volume, each of the one or more offset images offset from alignment with the first image by a respective number of images.

16. The computer program of claim 11, wherein generating the second image of the 3D approximate volume via the second machine learning model based on the 3D approximate volume comprises:
providing, as input to the second machine learning model, one or more offset images of the 3D approximate volume, each of the one or more offset images offset from alignment with the second image by a respective number of images.

17-20. (canceled)
